(19) United States
(12) Patent Application Publication
(10) Pub. No.: US 2011/0117383 A1
(43) Pub. Date: May 19, 2011

(54) SLIDING CONTACT MATERIAL

(76) Inventors: Takao Asada, Iwate (JP); Junichi Takeuchi, Iwate (JP); Tomokazu Satoh, Gunma (JP)

(21) Appl. No.: 13/002,678

(22) PCT Filed: May 28, 2010
(86) PCT No.: PCT/JP2010/059088

§ 371 Date: Jan. 5, 2011

(30) Foreign Application Priority Data
May 28, 2009 (JP) 2009-128906

(51) Int. Cl. B32B 15/01; C22C 5/02; C22C 30/04; C22C 30/00

(52) U.S. Cl. 428/669; 420/508; 420/589; 420/580

(57) ABSTRACT

A sliding contact material containing 40 to 60% by weight of Au, 15 to 25% by weight of Pd, and Sn and In as essential elements, the total amount of Sn and In being 1 to 4% by weight and the balance being Ag, and a sliding contact material containing 40 to 60% by weight of Au, 15 to 25% by weight of Pd, and Zn, the amount of Zn being 0.1 to 5% by weight and the balance being Ag. The sliding contact material is insusceptible to the interaction with grease essential for the use of such contact materials, and has stable contact resistance, and therefore can be used for a long time.

### TECHNICAL FIELD

The present invention relates to a contact material used in electrical and mechanical sliding portions such as small electric DC motors and slide switches.

### BACKGROUND ART

Materials of various compositions have been known in the past as contact materials used in electrical and mechanical sliding portions such as commutators for small electric DC motors and slide switches. For example, the present Applicant has disclosed such a material in Patent Document 1.

These contact materials have been discovered in order to ensure durability in a wide temperature range, and they are composed of, as a basic composition, an Au—Ag—Cu alloy prepared by adding Cu to an Au—Ag alloy, and a small amount of Pd, Ni and the like are further added thereto. The alloys are prepared by adding Cu, Pd and the like to an Au—Ag alloy which has been conventionally known as a contact material, and their durability is improved by suppressing wear caused by adhesion with maintaining the contact stability of the Au—Ag alloy.

### CITATION LIST

### Patent Document

Patent Document 1: Japanese Patent Application Laid-Open No. Hei 8-291349

### SUMMARY OF THE INVENTION

### Problem to be Solved by the Invention

The above-described contact materials are capable of meeting the demand made on them and have a certain level of durability. However, there is no limit to the demand for improving the performance of such materials, and materials having even higher durability than that of the above materials are needed to be developed. More specifically, the present inventors have found that even in the case of the above contact materials, when they are used, for example, for a commutator for small electric DC motors, the contact resistance increases if they are used for a long time, causing the problem of contact failure. Therefore, it has been studied to develop a material which can be used for a longer time than conventional ones. Under such circumstances, the present invention provides a contact material in electrical and mechanical sliding portions such as commutators for small electric DC motors, whose durability is improved in consideration of the environment where the material is used.

### Means for Solving the Problem

To solve the above problems, the present inventors have studied the relationship between the environment of use of contact materials and their durability. Generally, contact materials in sliding portions such as commutators for motors are used after being coated with olefin, ester or fluorine grease. This is because, if directly used, even materials having excellent wear resistance are worn out in short time and will be unusable any more. This means that using grease per se does not cause a problem. The studies of the present inventors, however, have revealed that the contact resistance of conventional contact materials tends to increase due to the interaction between the materials and grease in the process of use. It is considered that the interaction with grease means transformation of organic components in grease into some substance which causes contact failure, upon contact with contact materials.

Few studies have been done on the change in properties of contact materials caused by the interaction with grease. Generally, in the studies of properties of contact materials, wear properties of contact materials or temperatures upon use are mainly considered. Further, even if grease affects properties of contact materials, it is difficult to avoid the use of the grease. Under such circumstances, the present inventors have studied constituent elements and compositions of contact materials in consideration of the influence of grease, and have come up with the present invention.

Accordingly, the present invention provides a sliding contact material containing 40 to 60% by weight of Au, 15 to 25% by weight of Pd, and Sn and In as essential elements, the total amount of Sn and In being 1 to 4% by weight and the balance being Ag. The present invention also provides a sliding contact material containing 40 to 60% by weight of Au, 15 to 25% by weight of Pd, and Zn, the amount of Zn being 0.1 to 5% by weight and the balance being Ag.

The present invention is based on an Au—Ag—Pd alloy, and Cu which has been added in the above conventional art is not added thereto. This is because the elimination of Cu has a significant effect on the reduction of the influence of grease. The influence of grease is also associated with the additive amount of Pd. Although Pd is necessary for ensuring wear resistance of alloy, a high proportion of Pd increases the contact resistance due to grease. Therefore, in the present invention, the wear resistance of Au—Ag—Pd alloy without Cu has been improved by alloying with Sn and In or with Zn with adjusting the additive amount of Pd.

Referring to the composition range of the respective constituent elements of the contact material of the present invention, first Au is a metal for ensuring the conductivity and the corrosion resistance of the contact material. The corrosion resistance is decreased when the proportion of Au is less than 40% by weight, but there is little improvement in the property even when the proportion of Au is more than 60% by weight. Also, Pd improves wear resistance, and when the proportion of Pd is less than 15% by weight, the resulting alloy has reduced hardness and thus is more susceptible to wear. However, Pd is a constituent element which is likely to cause an increase in the contact resistance due to grease as described above, and so the upper limit thereof is 25% by weight.

In the present invention, an alloy is produced further with Sn and In or with Zn to improve wear resistance. Sn and In are added at a total concentration of 1 to 4% by weight, and when the total concentration is less than 1% by weight, the elements do not contribute to the improvement of the wear resistance. Also, when the total concentration is more than 4% by weight, Sn and In are oxidized and make the contact resistance unstable, even adversely affecting the processability of materials. For the additive amount of each of Sn and In, Sn is added in a proportion of 0.5 to 3.5% by weight and In is added in a proportion of 0.5 to 3.5% by weight, the total being within the above range. Also, Zn is added in an amount of 0.1 to 5% by weight. This is because when the amount is less than 0.1% by weight, the wear resistance is not improved, and when the amount is more than 5% by weight, Zn is oxidized to make the contact resistance unstable, and decreases the processability.

The sliding contact material described above is often used in the form of a clad material. In such a case, those prepared by joining a surface layer composed of the sliding contact material of the present application to a base layer composed of any of Cu and a Cu alloy are preferred.

### Advantageous Effects of Invention

As described above, the sliding contact material of the present invention is insusceptible to the interaction with grease and has stable contact resistance upon use. Therefore, the sliding contact material of the present invention can be used for a long time without causing contact failure.

The present invention is not only particularly suitable for commutators for small electric DC motors, but also suitable as a material for electrical and mechanical sliding portions such as slide switches.

### MODES FOR CARRYING OUT THE INVENTION

Examples and Comparative Examples of the present invention will be described below. In this embodiment, alloys of various compositions were produced and molded to investigate their properties. For the production of test materials, an alloy ingot of a predetermined composition was produced by arc melting, rolled to a thickness of 2 mm, and then the resultant was kept at 700° C. in N₂ atmosphere for 40 minutes to be annealed, and further rolled to 1 mm (rolling rate: 50%) to produce test materials. The properties of the test materials including the processability, the wear resistance, the corrosion properties and the influence of grease application were evaluated and studied.

For the evaluation of processability, the appearance of a test piece after rolling in the above process of forming into test materials was observed, and the piece was evaluated based on the presence of cracks. Those without cracks were evaluated as “having good processability: ∘” and those with cracks were evaluated as “having poor processability: x”.

Also, for the evaluation of wear resistance, the test material was pressed on a rotating disk material (Ag-50% by weight Pd alloy) for a predetermined time, and then the wear amount was measured to evaluate the wear resistance. The conditions of the wear test included a rotation speed of the disk of 50 rμm, a rotation number of 10,000 times and an additional load on the test material of 0.49 N. The wear amount (μm) was measured, and those with a wear amount of 5 μm or less were determined to be “excellent: [symbol] ”, those with a wear amount of 10 μm or less were determined to be “good: ∘” and those with a wear amount of more than 10 μm were determined to be “poor: x”.

Further, for the evaluation of corrosion resistance, the test materials were exposed to two types of corrosive environments and the contact resistance after the exposure was measured. The exposure environments in the corrosion test were a constant temperature and constant humidity environment (temperature: 85° C., humidity: 90% RH) and a corrosive gas environment (SO₂ gas, temperature: 40° C., humidity: 80% RH). The time of exposure was 240 hours in both environments. Also, to determine the influence of grease, grease was applied to the test materials and the contact resistance after a heat treatment at 300° C. for 10 minutes was measured. For the evaluation of the contact resistance in the corrosion test and the grease test, those with a resistance value of 10 mΩ or less were determined to be “excellent: [symbol] ”, those with a resistance value of 15 mΩ or less “good: ∘”, those with a resistance value of 25 mΩ or less “fair: Δ” and those with a resistance value of more than 25 mΩ “bad: x”.

The results of the above evaluation tests are shown in Table 1.

TABLE 1

| | | | | | | | | Evaluation results | | | | |
|---|---|---|---|---|---|---|---|---|---|---|---|---|
| | | | | | | | | | | Contact resistance | | |
| | | | | | | | | | | Constant | | |
| | | | | | | | | | | temperature | | |
| | Composition (% by weight) | | | | | | | Process- | Wear | constant | Gas | Application |
| | Pd | Au | Sn | In | Zn | Cu | Ag | ability | resistance | humidity | Corrosion | of grease |
| Example 1 | 16 | 42 | 1 | 1 | — | — | Balance | ◯ | [symbol] | [symbol] | [symbol] | [symbol] |
| Example 2 | 18 | 52 | 0.5 | 0.5 | — | — | Balance | ◯ | [symbol] | [symbol] | [symbol] | [symbol] |
| Example 3 | 18 | 52 | 1 | 1 | — | — | Balance | ◯ | [symbol] | [symbol] | [symbol] | [symbol] |
| Example 4 | 18 | 52 | 1 | 2.8 | — | — | Balance | ◯ | [symbol] | [symbol] | [symbol] | [symbol] |
| Example 4 | 18 | 52 | 1.8 | 1.8 | — | — | Balance | ◯ | [symbol] | [symbol] | [symbol] | [symbol] |
| Example 5 | 18 | 52 | 3 | 0.5 | — | — | Balance | ◯ | [symbol] | [symbol] | [symbol] | [symbol] |
| Example 6 | 20 | 42 | 1 | 1 | — | — | Balance | ◯ | [symbol] | [symbol] | [symbol] | [symbol] |
| Example 7 | 20 | 42 | 3 | 1 | — | — | Balance | ◯ | [symbol] | [symbol] | [symbol] | [symbol] |
| Example 8 | 20 | 50 | 1 | 1 | — | — | Balance | ◯ | [symbol] | [symbol] | [symbol] | [symbol] |
| Example 9 | 20 | 50 | 3 | 1 | — | — | Balance | ◯ | [symbol] | [symbol] | [symbol] | [symbol] |
| Example 10 | 23 | 57 | 1 | 1 | — | — | Balance | ◯ | [symbol] | [symbol] | [symbol] | [symbol] |
| Example 11 | 18 | 42 | — | — | 0.5 | — | Balance | ◯ | [symbol] | [symbol] | [symbol] | [symbol] |
| Example 12 | 18 | 42 | — | — | 1 | — | Balance | ◯ | [symbol] | [symbol] | [symbol] | [symbol] |
| Example 13 | 18 | 42 | — | — | 3 | — | Balance | ◯ | [symbol] | [symbol] | [symbol] | [symbol] |
| Example 14 | 18 | 42 | — | — | 4.5 | — | Balance | ◯ | [symbol] | ◯ | [symbol] | [symbol] |
| Example 15 | 20 | 42 | — | — | 3 | — | Balance | ◯ | [symbol] | ◯ | [symbol] | [symbol] |
| Example 16 | 23 | 50 | — | — | 3 | — | Balance | ◯ | [symbol] | [symbol] | [symbol] | [symbol] |
| Example 17 | 23 | 58 | — | — | 4.5 | — | Balance | ◯ | [symbol] | [symbol] | [symbol] | [symbol] |
| Comparative | 10 | 50 | 1 | 1 | — | — | Balance | ◯ | ◯ | [symbol] | [symbol] | [symbol] |
| Example 1 | | | | | | | | | | | | |
| Comparative | 30 | 42 | 1 | 1 | — | — | Balance | ◯ | ◯ | [symbol] | [symbol] | Δ |
| Example 2 | | | | | | | | | | | | |
| Comparative | 30 | 42 | 3 | 1 | — | — | Balance | ◯ | ◯ | [symbol] | [symbol] | Δ |
| Example 3 | | | | | | | | | | | | |
| Comparative | 30 | 42 | — | — | 3 | — | Balance | ◯ | ◯ | [symbol] | [symbol] | Δ |
| Example 4 | | | | | | | | | | | | |
| Comparative | 30 | 30 | 1 | 1 | — | — | Balance | ◯ | X | ◯ | [symbol] | Δ |
| Example 5 | | | | | | | | | | | | |
| Comparative | 40 | 30 | 1 | 1 | — | — | Balance | ◯ | X | [symbol] | ◯ | X |
| Example 6 | | | | | | | | | | | | |
| Comparative | 20 | 42 | 1 | 4 | — | — | Balance | X | — | — | — | — |
| Example 7 | | | | | | | | | | | | |
| Comparative | 20 | 50 | 1 | 4 | — | — | Balance | X | — | — | — | — |
| Example 8 | | | | | | | | | | | | |
| Comparative | 20 | 30 | — | — | — | — | Balance | ◯ | X | [symbol] | X | [symbol] |
| Example 9 | | | | | | | | | | | | |
| Conventional | — | 60 | — | — | — | 5 | Balance | ◯ | X | [symbol] | [symbol] | X |
| Example 1 | | | | | | | | | | | | |
| Conventional | 1 | 59 | — | — | — | 5 | Balance | ◯ | ◯ | [symbol] | [symbol] | X |
| Example 2 | | | | | | | | | | | | |

*Hatched items in Comparative Examples and Conventional Examples mean components whose amount is outside of the preferred composition range.
*Since no test material could be produced in Comparative Examples 7, 8 because of poor processability, the wear resistance and the contact resistance were not measured.

Table 1 first shows that the contact resistance of conventional Cu-containing contact materials (Conventional Examples 1, 2) has significantly increased with the application of grease, which is very different from the results of Examples which does not contain Cu and in which the amount of Pd is adjusted.

For the action of the respective constituent elements of the test materials of Examples, when the amount of Pd falls short of the appropriate range, materials have a poorer wear resistance, and when the amount of Pd exceeds the appropriate range, materials have an increased contact resistance due to grease (as seen from the comparison with Comparative Examples 1 to 4). Also, Au has an influence mainly on the corrosion resistance, and materials in which the amount of Au is below the appropriate range marked poor results in the corrosion test (as seen from the comparison with Comparative Example 5). Further, referring to the effect of adding Sn and In, or Zn, the more the additive amount is (Comparative Examples 7, 8), the poorer the processability will be, and resulting in the failure to produce test materials. On the other hand, without the addition of these elements (Comparative Example 9), materials have poor wear resistance, and the absence also has an impact on the stability of the contact resistance. These have confirmed that it is necessary to determine an appropriate composition range of the constituent elements by considering properties required for contact materials comprehensively based on the efficiency of processing into products (contact materials).

### INDUSTRIAL APPLICABILITY

The present invention provides a contact material in which the influence of grease indispensably used in electrical and mechanical sliding portions is reduced and which can be suitably used for small electric DC motors.

1. A sliding contact material comprising 40 to 60% by weight of Au, 15 to 25% by weight of Pd, and Sn and In as essential elements, the total amount of Sn and In being 1 to 4% by weight and the balance being Ag.

2. A sliding contact material comprising 40 to 60% by weight of Au, 15 to 25% by weight of Pd, and Zn, the amount of Zn being 0.1 to 5% by weight and the balance being Ag.

3. A clad composite material, comprising a surface layer composed of the sliding contact material according to claim 1 or 2 and a base layer composed of any of Cu and a Cu alloy joined to the surface layer.

4. A clad composite material, comprising a surface layer composed of the sliding contact material according to claim 2 and a base layer composed of any of Cu and a Cu alloy joined to the surface layer.
